(19) United States
(12) Patent Application Publication
(10) Pub. No.: US 2013/0117985 A1
(43) Pub. Date: May 16, 2013

(54) Screw

(71) Applicant: BSS Baumann Sicherheitssysteme GmbH, Radolfzell (DE)

(72) Inventors: Josef Siraky, Donaueschingen (DE); Markus Kuttruff, Donaueschingen (DE)

(73) Assignee: BSS Baumann Sicherheitssysteme GmbH, Radolfzell (DE)

(21) Appl. No.: 13/669,602

(22) Filed: Nov. 6, 2012

(30) Foreign Application Priority Data
Nov. 16, 2011 (DE) 10 2011 086 491.1

(51) Int. Cl. F16B 35/00; B25B 13/48

(52) U.S. Cl. CPC F16B 35/005; B25B 13/485
USPC 29/426.5; 81/53.2; 411/383

(57) ABSTRACT

The invention relates to a screw having a screw head, a screw end which lies opposite the screw head, and an external screw threading for the purpose of screwing the screw into a material, wherein the screw has at least two parts which are connected to each other via a detachable connection, wherein the screw head is arranged on another part than the external screw threading and the screw end, as well as a tool for the complete removal of such a screw.

### CROSS REFERENCE TO RELATED APPLICATIONS

The present application claims priority to German Patent Application No. 10 2011 086 491.1, filed on Nov. 16, 2011.

### STATEMENT REGARDING FEDERALLY SPONSORED RESEARCH OR DEVELOPMENT

No federal government funds were used in researching or developing this invention.

### NAMES OF PARTIES TO A JOINT RESEARCH AGREEMENT

Not applicable.

### SEQUENCE LISTING INCLUDED AND INCORPORATED BY REFERENCE HEREIN

Not applicable.

### FIELD OF THE INVENTION

The screws which serve to fix the profile cylinder of a lock in the lock barrel are particularly called set screws. This fixing, which typically is realized by the screw end of the set screw, is necessary so that the cylinder cannot be easily removed from the lock or pushed in, wherein the latter would lead to the lock being able to be opened without a matching key.

Because of the significance of a set screw for the security which a lock offers, it is not surprising that effort is expended to make an unauthorized removal of the set screw as complicated as possible. The standard measure which is used to achieve this goal is that of arranging the bore hole into which the set screw is inserted at a position which is inaccessible when the door is closed. As a result, set screws are generally designed as countersunk screws having a threading, wherein the screw head thereof closes flush with a material surface when the screw is fully inserted into a material.

### BACKGROUND

Countersinking of a set screw, taken alone, constitutes an inadequate security measure if this countersunk screw can be easily and quickly removed when the door is open. This is because in this case a brief distraction can offer a criminal the necessary time to remove the screw, wherein it is then possible at a suitable later time to break into the object which is no longer effectively secured by the lock, which can be removed. For this reason, the approach is known in the prior art of deviating from the common standards for shapes of the depressions in the screw head, wherein a screwdriver engages in said depressions for the purpose of removing the screw, said shapes including a slot, a cross-slot, or a countersunk hex shape, for example, and therefore require the use of a special tool which is less commonly available and optionally is only released to a limited group of people. However, this approach ultimately only achieves a minimal reduction of the risk of the set screw being removed.

The problem addressed by the invention is that of providing a screw wherein the removal thereof from an open door, said screw being used as the set screw, is only possible with increased effort, wherein the screw is nevertheless easy to insert into the door during installation. The problem addressed by the invention is also that of providing a tool for the complete removal of such a screw, and a method for the complete removal of such a screw by means of such a tool.

### SUMMARY OF THE INVENTION

The invention relates to a screw comprising at least two parts, one of which is an internal component which can be detached to prevent unauthorized removal of the screw after deployment.

In a preferred embodiment, a screw comprising a screw head, a screw end disposed opposite the screw head, and an external screw threading for the purpose of screwing the screw into a material, further comprising wherein the screw has at least two parts connected to each other via a detachable connection, wherein the screw head is arranged on a part which is different from the part having the external screw threading and the screw end.

In another preferred embodiment, the screw as disclosed, further comprising wherein the part which has the external screw threading and the screw end has a bore hole which fully passes through said part, wherein a tensioning means is arranged in said bore hole to tension the external screw threading when the screw is used.

In another preferred embodiment, the screw as disclosed, further comprising wherein the connection between the part of the screw which comprises the screw head and at least one further part of the screw is an internal screw connection, wherein the threading of the internal screw connection has a greater pitch than the external screw threading.

In another preferred embodiment, the screw as disclosed, further comprising wherein that the male part of the inner screw connection is arranged on the part which has the screw head.

In another preferred embodiment, the screw as disclosed, further comprising wherein the female part of the inner screw connection is arranged on the part which has the screw head.

In another preferred embodiment, the screw as disclosed, further comprising wherein at least one protuberance or recess is arranged on the side of the part which has the external screw threading, said part lying opposite the screw end when the parts of the screw are connected to each other, wherein a positive-fit connection with a tool can be produced by means of said protuberance or recess.

In a preferred embodiment, a tool for the complete removal of a screw according to one of the previous claims, further comprising wherein the tool has means for the production of a torque-proof connection with the part of the screw which comprises the external screw threading.

In another preferred embodiment, the tool as disclosed, further comprising wherein the means for the production of a torque-proof connection with the part of the screw which comprises the external screw threading are tensioning means, particularly inner screws.

A method for the removal of a screw as disclosed by means of a tool as disclosed, comprising the steps: removal of the part of the screw which comprises the screw head, production of a torque-proof connection between the tool and the part of the screw which comprises the external threading, and removal of the part of the screw which comprises the external threading by means of the tool.

In another preferred embodiment, the method as disclosed, further comprising wherein a tensioning of the part of the screw which comprises the external threading is released between the step of removing the part of the screw which comprises the screw head, and the step of producing a torque-proof connection between the tool and the part of the screw which comprises the external threading.

### BRIEF DESCRIPTION OF THE DRAWINGS

These and other features of the invention will become more apparent in the following detailed description in which reference is made to the appended drawings.

FIG. 1a evidences a three-dimensional, partial cutaway illustration of a two-part screw according to a first embodiment of the invention.

FIG. 1b evidences a cutaway view of a screw according to one variant of the first embodiment of the invention.

FIG. 2a evidences the individual components of a two-part screw according to a second embodiment of the invention.

FIG. 2b evidences the screw assembled from the individual components in FIG. 2a.

FIG. 3a evidences the individual components of a two-part screw according to a third embodiment of the invention.

FIG. 3b evidences the screw assembled from the individual components in FIG. 3a.

FIG. 3c evidences a view of the side of the part in FIG. 3a having the external screw threading, which, when the parts of the screw are connected with each other, lies opposite the screw end.

FIG. 4 evidences a first embodiment of a tool for the complete removal of a screw according to the invention.

FIG. 5 evidences a three-dimensional, partial cutaway illustration of a second embodiment of a tool for the complete removal of a screw according to the invention.

FIG. 6 evidences a three-dimensional, partial cutaway illustration of a three-part screw according to a fourth embodiment of the invention.

### DETAILED DESCRIPTION OF THE INVENTION

Unless defined otherwise, all technical and scientific terms used herein have the same meaning as commonly understood by one of ordinary skill in the art to which this invention belongs.

The invention will now be described with reference to specific examples. It will be understood that the following examples are intended to describe embodiments of the invention and are not intended to limit the invention in any way.

The screw according to the invention comprises a screw head, a screw end which is disposed opposite the screw head, and an external screw threading for the purpose of screwing the screw into a material. In the context of this patent application, the screw head is considered the component of the screw which has the means for creating a positive fit with the tool used to insert the screw, meaning the component having a cross-slot, a slot, or a hex- or star-shaped depression, by way of example and not limitation. The screw end is the part of the screw which penetrates into the material the deepest when the screw is screwed into the material. The external screw threading is the threading of the screw which interacts with the material when the screw is screwed into the material. The term material also includes any counter threading which may be present.

It is essential to the invention that the screw has at least two parts which are connected to each other via a detachable connection, wherein the screw head is arranged on a part which is different than the part having the external threading and the screw end. By providing a screw which is constructed of multiple parts which are connected to each other as such in a detachable manner, the possibility is created that the connection between the parts is broken at the screw head during an attempt at removing the screw, such that the part which has the external screw threading, the same ensuring the actual securement of the lock cylinder, is not removed with the screw head. This is particularly the case if a connection is provided which is only broken when the screw is rotated in the direction in which it is rotated to remove the screw. The direction is prespecified by the design of the external screw threading.

Such a screw can be designed as particularly secure if the part which has the external screw threading and the screw end has a bore hole which fully passes through said part, wherein a tensioning means is arranged in said bore hole to tension the external screw threading when the screw is used. In this way, this part can be wedged in such a manner that the removal thereof is not possible, particularly if the part which has the external screw threading and the screw end has a slotted section proceeding from the screw end.

A particularly simple alternative for providing such a detachable connection is realized if the connection between the part of the screw which has the screw head and at least one further part of the screw is an internal screw connection, wherein the threading of the internal screw connection has a greater pitch than the external screw threading. However, other types of detachable connections can be contemplated, including a magnetic connection, for example, which is strengthened upon the application of a special tool with a corresponding magnetic tip such that the necessary torque resistance results, enabling both parts of the screw to be removed together.

The term “screw connection” in this case is used for a connection between two parts wherein a male part which comprises a threading is at least partially screwed into a female part which has an opening with a counter threading arranged therein, when in the connected state. The screw connection is termed an “inner screw connection” in order to make it clear that it is a connection between two parts of the screw, wherein this connection is arranged in the interior of the screw, particularly when the same is assembled, and therefore is not visible, in contrast to the outer screw threading.

As a result of the increased pitch of the threading of the inner screw connection, the same is broken upon the application of a torque to the screw head which is not sufficient to make the outer screw threading rotate. In practice, inner screw threadings wherein the threading of the inner screw connection is designed with a thread pitch which is at least three times larger than the external screw threading have proven particularly suitable.

As an alternative, or additionally thereto, it is also possible to include an inner screw connection as the connection between the part of the screw which has the screw head and at least one further part of the screw, and to design the external screw threading to be as difficult to access as possible.

If the inner screw connection is designed such that the male part of the inner screw connection is arranged on the part which has the screw head, and the female part of the inner screw connection is arranged on the part which has the screw end and the external threading, a screw results which is particularly cost-effective to produce. In this case, a conventional screw can be used as the part having the screw head, wherein the external threading of the conventional screw forms the threading of the male part of the inner screw connection, while the part of the screw which has the screw end and the external threading of the set screw can be formed by a segment of a threaded rod, for example, wherein a bore hole is made in the same, with an inner threading cut into said bore hole which forms the female part of the inner screw connection.

In contrast, if the inner screw connection is designed in such a manner that the female part of the inner screw connection is arranged on the part which has the screw head, and the male part of the inner screw connection is arranged on the part which has the screw end and the external screw connection, a composite screw results wherein a tool made for the removal of the part of the screw which contains the screw end and the external screw threading can be brought into a particularly tight connection with the inner screw connection by means of jamming with the male part thereof. A concrete example for this approach is explained thoroughly below.

In the event that measures are taken to create an external threading which is difficult to access, such an improved contact between the tool and the screw part having the screw end and the external screw threading can be particularly important.

In a further advantageous embodiment of the invention, at least one protuberance or recess is arranged on the side of the part which has the external screw threading, said part lying opposite the screw end when the parts of the screw are connected to each other, wherein a positive-fit connection with a tool can be produced by means of said protuberance or recess. Like the embodiment described in the previous paragraph, this measure also serves to increase the torque resistance of the connection between this part of the screw and a tool for the removal of this part, and thereby enable the reliable removal thereof.

The tool according to the invention for the complete removal of a screw according to the invention is characterized in that the tool has means for the production of a torsion-proof connection to the part of the screw which has the external screw threading. A torque-proof connection in the context of this patent application is characterized in that it offers a higher resistance to the rotation of the tool and the part of the screw which has the external screw threading relative to each other than the resistance to the removal of the external screw threading from the material which receives the threading.

In one advantageous implementation of such a tool, the means for the production of a torque-proof connection are designed as tensioning means, particularly inner screws, which are arranged in such a manner that they are able to effect a tensioning of the threading and the counter threading by the tool and a part of the screw in the region of the threading which has the greater pitch. In this way, it is possible to provide, in a simple manner, the necessary breakaway torque for the installed screw.

The method according to the invention for the removal of a screw according to the invention by means of a tool according to the invention has the following steps: removal of the part of the screw which has the screw head, production of a torque-proof connection between the tool and the part of the screw which has the external threading, and removal of the part of the screw which has the external threading, by means of the tool.

In one implementation of the method which is preferred because of the particularly good security achieved by the same, a removal of the part of the screw having the external threading is enabled in that a tensioning of the part of the screw having the external threading is released between the step of the removal of the part of the screw having the screw head and the step of producing a torque-proof connection between the tool and the part of the screw having the external threading.

### DESCRIPTION OF THE FIGURES

Turning now to the Figures, identical components of the same exemplary embodiments of the terminal are marked in all figures with the same reference characters, unless indicated otherwise. Further, individual features illustrated based on different exemplary embodiments can be freely combined unless they contradict each other.

The following comprises a listing of parts and associated parts numbers, as used in the Figures described herein beneath:

100, 200, 300, 600 screw

110,120,210,220,310,320,610, 620 part of the screw

111, 211, 311, 611 screw head

121, 221, 321, 621 external screw threading

122, 222, 322, 622 screw end

130, 230, 330, 630 inner screw connection

131, 231, 331, 631 male part

132, 232, 332, 632 cylindrical segment

133, 233, 333, 633 threading

135, 235, 335, 635 female part

136, 236, 336, 636 cylindrical bore hole

137, 237, 337, 637 counter threading

138 second bore hole

139 opposite threading

220a, 220b, 220c segment

320a, 320b, 320c, 320d segment

341, 342 recesses

400, 500 tool

410, 510 inner screw

411 head

412, 422, 514 threading

413 tensioning lever arm

414 opening

420 working screw

421, 511 screw

423 working lever arm

501 socket

502 counter threading

503, 515 hex head

504 opening

512 end

513 threading segment

650 bore hole

651 slot

660 tensioning means

661 threading segment

662 expanding mandrel head

In the figures, the same reference numbers are used for identical components of the same embodiment of the invention, unless otherwise noted. The individual features of the various embodiments can be freely combined, unless they contradict each other.

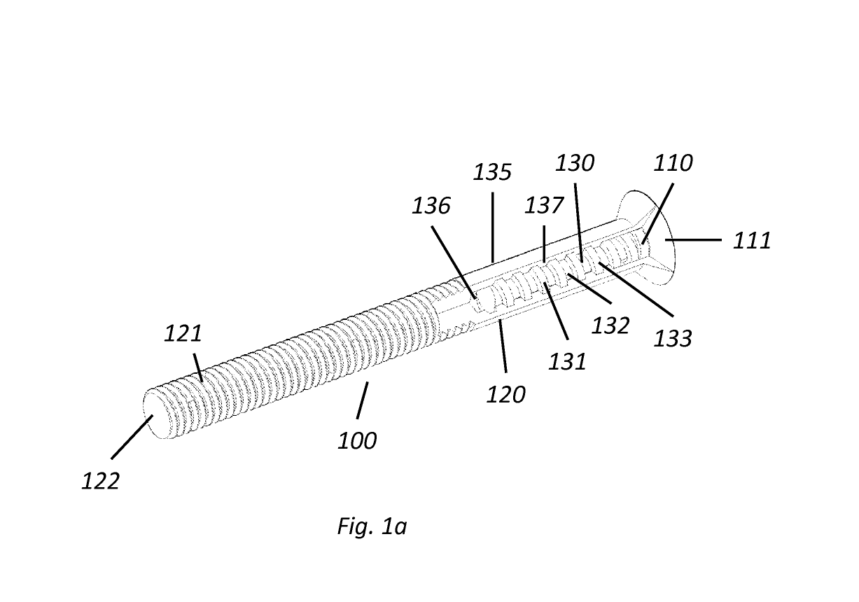

FIG. 1a shows a three-dimensional, partial cutaway view of a screw 100 according to a first embodiment of the invention, having a screw head 111, an external screw threading 121, and a screw end 122. The screw 100 consists of a part 110 on which the screw head 111 is arranged, and a part 120 on which the external screw threading 121 and the screw end 122 are arranged—meaning the screw 100 consists of a total of two parts 110, 120.

The two parts 110, 120 are connected to each other via an inner screw connection 130. The inner screw connection 130 is formed by a male part 131 consisting of a cylindrical segment 132 with a threading 133 made thereon, and a female component 135 consisting of a cylindrical bore hole 136 and a counter threading 137 cut into the same. Of course, as is generally known of screws, in principle it is possible to use a conical profile segment for the male part 131 and a corresponding conical recess for the female part 135. This is not shown.

In the context of FIG. 1a, it is particularly important to note the difference between the external screw threading 121 and the threading 133 included on the male part 131 of the inner screw connection 130. The pitch of the threading 133 is larger than the pitch of the external screw threading 121. As a result, the threading 133 can be rotated upon the application of a smaller rotational torque, while the external screw threading 121 cannot yet be rotated. This effect is further increased in that the turns of the threading 133 are designed to be significantly larger than the turns of the external screw threading 121.

As a result, upon an attempt to remove the screw 100 from a material which receives it, the inner screw connection 130 is initially unscrewed, such that the part 110 is removed together with the screw head 111, while the part 120 with the external screw threading 121 and the screw end 122 remains behind in the material, such that when the screw is used as a set screw, the securement of a lock cylinder, which is not illustrated, is preserved. In this case, the screw 100 is not recognizable as a safety screw, and when it is screwed in on the part 110, it remains assured that the threading 121 can be rotated up to the limit stop of the countersunk head, and that it is possible to apply the torque required to fasten the screw.

The variant of the two-part screw 100 illustrated in FIG. 1b differs from the two-part screw 100 illustrated in FIG. 1a in that a second bore hole 138 with a smaller diameter than that of the cylindrical bore hole 136 is arranged concentrically to the cylindrical bore hole 136, and an opposing threading 139 is arranged in said second bore hole 138 which has the rotational direction which is opposite that of the external screw threading 121 and the threading 133, and the counter threading 137 of the inner screw connection 130. If, for example, as is normally the case, the external screw threading 121 and the threading 133 and counter-threading 137 of the inner screw connection 130 are designed as right-handed threadings, the opposing threading 139 would be designed as a left-handed threading.

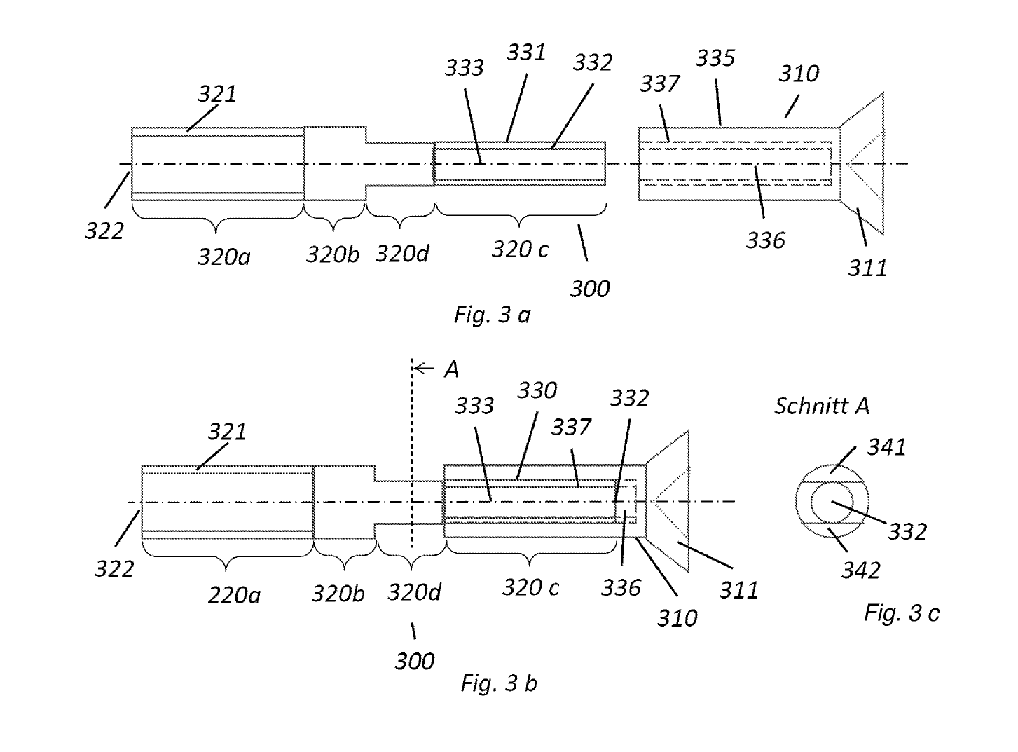

This makes it possible to simply use a threaded rod or screw with a corresponding counter-threading to remove the part 120 of the two-part screw 100, rather than a tool, as can be seen in FIG. 4 for example. This threaded rod or screw can be screwed into the threading 139 up to a limit top. If a torque is then further applied in the direction of insertion of the threaded rod or screw, this leads to the unscrewing of the part 120 of the two-part screw 100.

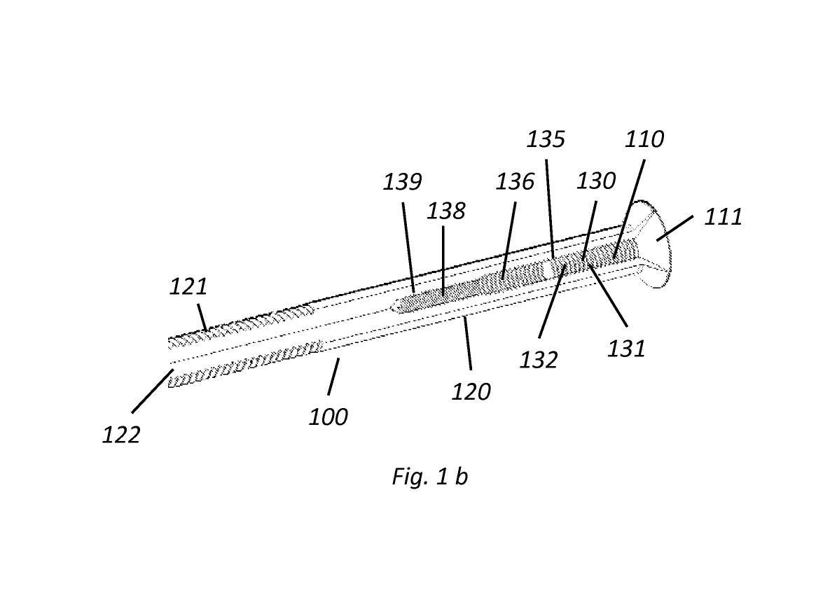

A second embodiment of a two-part screw 200 having a screw head 211, an external screw threading 221, and a screw end 222 is illustrated in FIGS. 2a and 2b, wherein FIG. 2a shows the two parts 210, 220 of the two-part screw 200 separated from each other, and FIG. 2b shows the two parts 210, 220 connected to each other.

In the case of this embodiment as well, the two parts 210, 220 are connected to each other via an inner screw connection 230. In contrast to the embodiment shown in FIG. 1a and the variants thereof shown in FIG. 1b, the male part 231 in this case, consisting of a cylindrical segment 232 with a threading 233 made thereon, is arranged on the part 220 of the screw 200 which also has the external screw threading 221 and the screw end 222—and particularly in such a manner that it extends coaxially to the central axis of the screw in the direction of the screw head 211.

As can be seen particularly clearly in FIG. 2a, the part 220 of the screw 200 has a first segment 220a proceeding from the screw end 222, and this first segment 220a carries the external screw threading 221. A second segment 200b connects to the first segment, and has no threading, but rather has a smooth surface. A third segment 220c follows this and is formed by the male part 231 of the inner screw connection 230.

It is hereby noted that one variant of an embodiment of the part 220 having three segments 220a, 220b, 220c can be designed in a manner allowing simple, cost-effective production, leading to a three-part screw, if two segments of threaded rods having different diameters and different thread pitch are concentrically connected on end faces thereof which face each other, and the segment 220b is realized by sliding a sleeve thereover which has a matching inner and outer diameter.

The inclusion of the second, unstructured segment 220b is particularly practical in the case of long screws, in order to limit the need to include the external screw threading 221, the threading 233 of the male part 231, and the counter-threading 237 to the shortest possible segments of the screw 200, enabling a cheaper production thereof.

Accordingly, the female part 235 of the inner screw connection 230, consisting of a cylindrical bore hole 236 and a counter-threading 237 cut therein, is arranged on the part 210 of the screw 200 which has the screw head 211.

As is clearly illustrated in FIGS. 2a and 2b, the pitch of the threading 233 in this embodiment of the invention is also larger than the pitch of the external screw threading 221, whereby the threading 233 can be rotated upon the application of a smaller torque than is required to rotate the external screw threading 221.

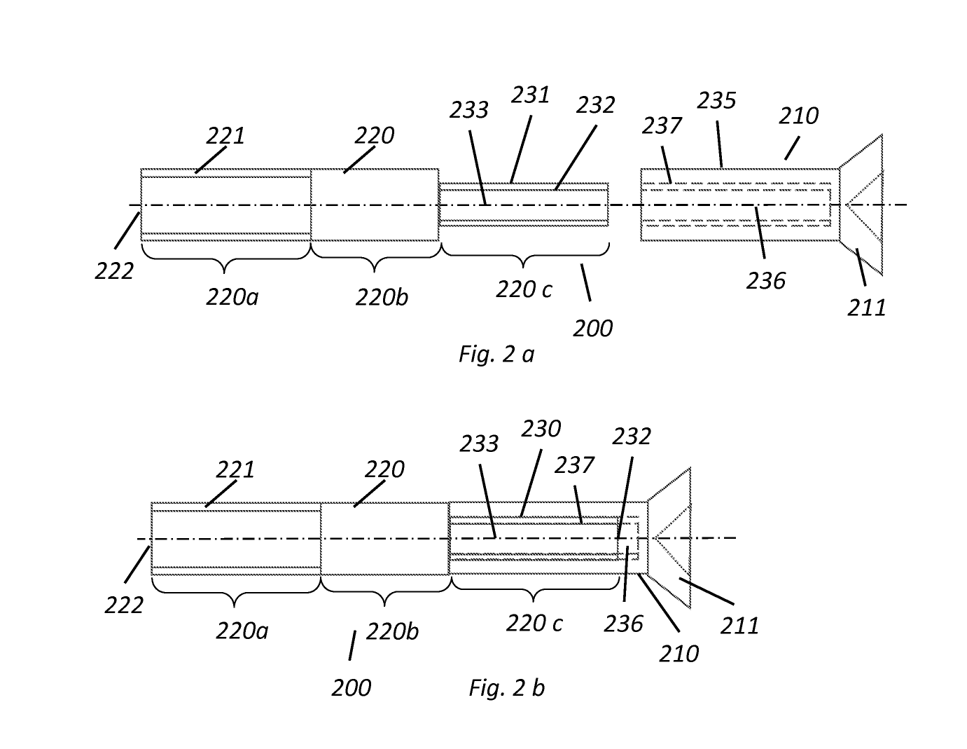

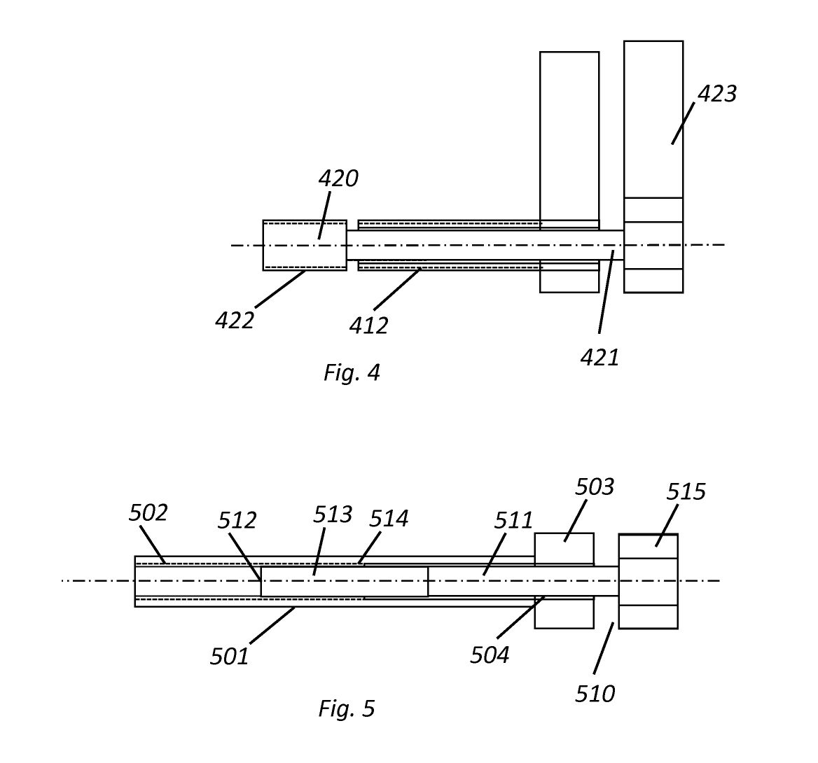

A third embodiment of a two-part screw 300 according to the invention is shown in FIGS. 3a to 3c, wherein FIG. 3a shows the two parts 310, 320 of the two-part screw 300 separated from each other, and FIG. 3b shows the two parts 310, 320 connected to each other. In this case, the screw 300 according to the third embodiment only differs from the screw 200 according to the second embodiment in that the part 320 having the external screw threading 321 and the screw end 322 has a fourth segment 320d which is arranged between the segments 320b and 320c. As can be seen particularly clearly in FIG. 3c, this segment has two recesses 341, 342 which are suitable for producing a positive-fit connection to a tool which has protuberances which are complementary to the recesses 341, 342. This tool is simpler to produce than the tool shown in FIG. 5, for example.

However, it should hereby be noted that a simple construction of the additionally required tools, as found in the variants of the invention illustrated in FIGS. 1b and/or 3a and 3b, should be considered irrelevant, because this leads to these additional tools being widely distributed.

As can be seen in each of the figures la to 3b, the inner screw connection 130, 230, 330 is designed, as is practical (but not necessary), in such a manner that the parts 110, 120, 210, 220, 310, 320 of the screw 100, 200, 300 form a surface when assembled which runs substantially flat on the boundary and/or on the transition point between the parts 110, 120, 210, 220, 310, 320, such that no significant step-up is created. It is likewise practical to arrange each threading concentrically to the common screw axis.

FIG. 4 shows an embodiment of a tool 400 for the removal of the part 120 of a screw 100 having the screw end 122, having a construction as illustrated in FIG. 1a. The tool 400 has an inner screw 410 which has a six-sided head 411 and a threading 412 which is matched to the counter-threading 137. A tensioning lever arm 413 is arranged in a positive fit connection, with respect to a rotary movement about the longitudinal axis of the inner screw 410, with the hex head 411 of said inner screw 410. This tensioning lever arm 413 can also be implemented as a box-end or open-end wrench, by means of which a torque can be exerted on the inner screw 410. The use of pliers can also be contemplated.

A profiled shaft 421 of a working screw 420, said shaft 421 being able to rotate relative to the opening 414, is guided through an opening 414 which passes through the inner screw 410. The threading 422 of said working screw 420 is likewise matched to the counter threading 137. A working lever arm 423 has a positive-fitting connection, with respect to rotary movements about the longitudinal axis of the working screw 420, to the profiled shaft 421, and can also be implemented as a box-end or open-end wrench, or as pliers, given a corresponding profile design of the profiled shaft 421.

To remove the screw 100, first the part 110 is unscrewed with a standard tool, while the part 120 remains in its position due to the different pitches of the threadings. To remove the remaining part 120 of the screw 100, first the threading 422 of the working screw 420 is screwed into the female part 135 of the inner screw connection 130. Next, the inner screw 410, with the opening 414 which passes through the same, is placed on the profiled shaft 421, and the threading 412 of the inner screw 410 is likewise screwed into the female part 135 of the inner screw connection 130, particularly in such a manner that the threading 422 of the working screw 420 is tensioned by the counter threading 137. This has the result that a force which engages the working lever arm 423 generates a torque which is transmitted to the part 120 of the screw 100, such that the same is removed from the material which surrounds it when the force is applied in the corresponding direction.

FIG. 5 shows one embodiment of a tool 500 which is used for a design of the screw 200 according to FIGS. 2a and 2b. The tool 500 has a socket 501 with a counter threading 502 which matches the threading 233 of the male part 231 of the inner threading 230 of the screw 200, said counter threading 502 arranged on the inner side of the socket 501, and has a hex head 503 which has an opening 504 lying on the center axis of the socket 501. A shaft 511 of an inner screw 510 is guided through the opening 504 in such a manner that the shaft 511 can rotate in the opening 504. A threading segment 513 is included on the end 512 of the shaft 511 which faces the screw end 222 when the tool 500 is used as intended, and this threading segment 513 has a threading 514 which is likewise matched to the threading 233 of the male part 231 of the inner threading 230 of the screw 200. The shaft 511 has a hex head 515 in the end region of the same which lies opposite the end 512. In principle, another means for the production of a positive fit connection with a tool which engages at this point can also be used, instead of the hex heads 503, 515.

To remove the screw 200, first the part 210 is unscrewed with a standard tool, while the part 220 remains in its position due to the different pitches of the threadings. To remove the remaining part 220 of the screw 200, the socket 501 is screwed onto the male part 231 of the inner screw connection 230. Next, the inner screw 510 is screwed into the socket 501 such that the male part 231 is tensioned by means of the counter threading 502. The part 220 of the screw 200 can then be removed by rotation applied to the hex head 503.

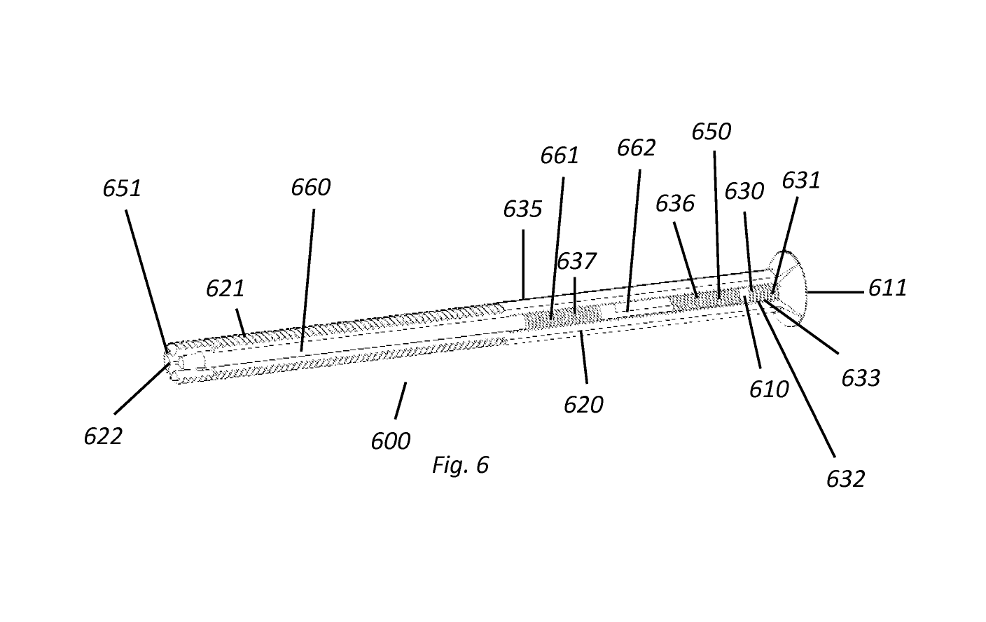

FIG. 6 shows a three-dimensional, partial cutaway view of a screw 600 according to a fourth embodiment of the invention, having a screw head 611, an external screw threading 621, and a screw end 622. The screw 600 consists of a part 610 on which the screw head 611 is arranged, a part 620 which has a bore hole 650 which passes through said part 620, on which the external screw threading 621 and the screw end 622 are arranged, and a tensioning means 660—meaning a total of three parts 610, 620, and 660.

The two parts 610, 620 are connected to each other via an inner screw connection 630. The inner screw connection 630 is formed by a male part 631 consisting of a cylindrical segment 632 with a threading 633 made thereon, and a female component 635 consisting of a cylindrical bore hole 636 and a counter threading 637 cut into the same. It is essential to the functionality of the embodiment of the invention shown in FIG. 6 that the female part 635 is longer than the male part 631, and that the cylindrical bore hole 636 is a segment of the bore hole 650 which passes through the part 620. Proceeding from the screw end 622, slots 651 pass through the wall of a segment of the bore hole 650, which narrows in the slotted region toward the screw end 622.

The tensioning means 660 is designed as an expanding mandrel having a threading segment 661 and an expanding mandrel head 662 which is designed for the purpose of producing a positive fit connection to a tool which is not illustrated, wherein the threading segment 661 is designed to match the counter threading 637. If a positive fit is produced between the expanding mandrel head 662 and the tool, the expanding mandrel can therefore be moved in the direction of the screw end 622 or away from the screw end by means of rotation of the tool. If the end of the tensioning means 660 which lies opposite the expanding mandrel 662 reaches the slotted region, the same is pushed apart and tensions the part 620 against the material surrounding it.

As a result, upon an attempt to remove the screw 600 from a material which receives it, the inner screw connection 630 is initially unscrewed, such that the part 610 is removed together with the screw head 611, while the part 620 with the external screw threading 621 and the screw end 622 remains behind in the material, such that when the screw is used as a set screw, the securement of a lock cylinder, which is not illustrated, is preserved. The screw 600 is not recognizable as a safety screw, and when it is screwed in on the part 610, it remains assured that the threading 621 can be rotated up to the limit stop of the countersunk head, and that it is possible to apply the torque required to fasten the screw.

To remove the part 620 of the screw 600 which secures the lock cylinder, the tensioning means 660 must therefore first be changed from the tensioning position into the non-tensioning position by means of a first tool, following the removal of the part 610, before the part 620 which secures the lock cylinder can be removed by means of a second tool.

Any references cited herein are incorporated herein in their entirety, particularly as they related to teaching the level of ordinary skill in this art and for any disclosure necessary for the commoner understanding of the subject matter of the claimed invention. It will be clear to a person of ordinary skill in the art that the above embodiments may be altered or that insubstantial changes may be made without departing from the scope of the invention. Accordingly, the scope of the invention is determined by the scope of the following claims and their equitable Equivalents.

We claim:

1. A screw comprising a screw head, a screw end disposed opposite the screw head, and an external screw threading for the purpose of screwing the screw into a material, further comprising wherein the screw has at least two parts connected to each other via a detachable connection, wherein the screw head is arranged on a part which is different from the part having the external screw threading and the screw end.

2. The screw of claim 1, further comprising wherein the part which has the external screw threading and the screw end has a bore hole which fully passes through said part, wherein a tensioning means is arranged in said bore hole to tension the external screw threading when the screw is used.

3. The screw of claim 1, further comprising wherein the connection between the part of the screw which comprises the screw head and at least one further part of the screw is an internal screw connection, wherein the threading of the internal screw connection has a greater pitch than the external screw threading.

4. The screw of claim 3, further comprising wherein that the male part of the inner screw connection is arranged on the part which has the screw head.

5. The screw of claim 3, further comprising wherein the female part of the inner screw connection is arranged on the part which has the screw head.

6. The screw of claim 1, further comprising wherein at least one protuberance or recess is arranged on the side of the part which has the external screw threading, said part lying opposite the screw end when the parts of the screw are connected to each other, wherein a positive-fit connection with a tool can be produced by means of said protuberance or recess.

7. A tool for the complete removal of a screw according to claim 1, wherein the tool has means for the production of a torque-proof connection with the part of the screw which comprises the external screw threading.

8. The tool of claim 7, further comprising wherein the means for the production of a torque-proof connection with the part of the screw which comprises the external screw threading are tensioning means, particularly inner screws.

9. A method for the removal of a screw by means of a tool according to claim 7, comprising the steps: removal of the part of the screw which comprises the screw head, production of a torque-proof connection between the tool and the part of the screw which comprises the external threading, and removal of the part of the screw which comprises the external threading by means of the tool.

10. The method of claim 9, further comprising wherein a tensioning of the part of the screw which comprises the external threading is released between the step of removing the part of the screw which comprises the screw head, and the step of producing a torque-proof connection between the tool and the part of the screw which comprises the external threading.
